(19) United States
(12) Patent Application Publication
(10) Pub. No.: US 2026/0112534 A1
(43) Pub. Date: Apr. 23, 2026

(54) COIL COMPONENT

(71) Applicant: SAMSUNG ELECTRO-MECHANICS CO., LTD., Suwon-si (KR)

(72) Inventors: Tae Hyun KIM, Suwon-si (KR); Dong Hwan LEE, Suwon-si (KR); Dong Jin LEE, Suwon-si (KR); Kang Ryong CHOI, Suwon-si (KR); Jung Wook SEO, Suwon-si (KR)

(73) Assignee: SAMSUNG ELECTRO-MECHANICS CO., LTD., Suwon-si (KR)

(21) Appl. No.: 19/296,160

(22) Filed: Aug. 11, 2025

(30) Foreign Application Priority Data
Oct. 21, 2024 (KR) 10-2024-0144032

(51) Int. Cl. H01F 27/29; H01F 27/255; H01F 27/28

(52) U.S. Cl. CPC H01F 27/29; H01F 27/255; H01F 27/2828

(57) ABSTRACT

A coil component includes a body having a first surface and a second surface facing each other in a first direction, and a first side surface and a second side surface facing each other in a second direction. The body includes a magnetic material and a support member disposed therein. The support member has a through-hole and a coil disposed on at least one of its surfaces. External electrodes are disposed on the first side surface, the second side surface, and the first surface of the body. A first insulating layer is disposed on the second surface. The body includes a molded portion having opposing surfaces in the first direction and side surfaces connecting them. A core protrudes from a surface of the molded portion and extends through the through-hole. A cover portion is disposed on the molded portion to provide structural support and enhanced magnetic performance.

### CROSS-REFERENCE TO RELATED APPLICATION(S)

This application claims the benefit of priority to Korean Patent Application No. 10-2024-0144032 filed on Oct. 21, 2024 with the Korean Intellectual Property Office, the disclosure of which is incorporated herein by reference in its entirety.

### TECHNICAL FIELD

The present disclosure relates to a coil component.

Inductors, coil components, are representative passive devices forming electronic circuits together with resistors and capacitors to remove noise. Inductors have been used in combination with capacitors in resonant circuits, filter circuits, etc., to amplify a signal within a specific frequency band using electromagnetic characteristics.

In the case of an inductor having a wound coil, a body may have a T-core structure formed using a mold. However, in the case of an inductor having a thin-film coil, it may be difficult to implement such a structure.

### SUMMARY

An aspect of the present disclosure is to provide a coil component capable of diversifying a structure and characteristics.

According to an aspect of the present disclosure, a coil component includes: a body including a first surface and a second surface facing each other in a first direction and a first side surface and a second side surface, facing each other in a second direction, and including a magnetic material; a support member disposed within the body, including a first surface and a second surface facing each other in the first direction, and having a through-hole formed in the first surface and the second surface; a coil disposed on at least one of the first surface and the second surface of the support member; an external electrode disposed on the first side surface, the second side surface, and the first surface of the body; and a first insulating layer disposed on the second surface of the body, wherein the body includes a molded portion including first surface and the second surface opposing each other in the first direction and a plurality of side surfaces connecting the first surface and the second surface and including a core protruding from the first surface and penetrating through the through-hole and a cover portion disposed on the first surface of the molded portion, and the second surface of the molded portion forms the second surface of the body.

According to another aspect of the present disclosure, a coil component includes: a body including a first surface and a second surface facing each other in a first direction and a first side surface and a second side surface, facing each other in a second direction, and including a magnetic material; a support member disposed within the body, including first surface and the second surface facing each other in the first direction, and having a through-hole formed in the first surface and the second surface; a coil disposed on at least one of the first surface and the second surface of the support member; and an external electrode disposed on the first side surface and the second side surface of the body, wherein the body includes a molded portion including first surface and the second surface opposing each other in the first direction and a plurality of side surfaces connecting the first surface and the second surface and including a core protruding from the first surface and penetrating through the through-hole and a cover portion disposed on the first surface of the molded portion, the molded portion includes ferrite, and the cover portion includes a resin and magnetic metal particles dispersed in the resin.

### BRIEF DESCRIPTION OF DRAWINGS

Other aspects, features, and advantages of the present disclosure will be more clearly understood from the following detailed description, taken in conjunction with the accompanying drawings, in which:

FIG. 1 is a perspective view schematically illustrating a coil component of a first embodiment of the present disclosure;

FIG. 2 is an exploded perspective view of a coil of FIG. 1;

FIG. 3 is a cross-sectional view taken along line I-I′ of FIG. 1;

FIG. 4 is an enlarged view of portions A and B of FIG. 3;

FIG. 5 is an enlarged view of portions A and B of FIG. 3, illustrating a modified example of the first embodiment of the present disclosure;

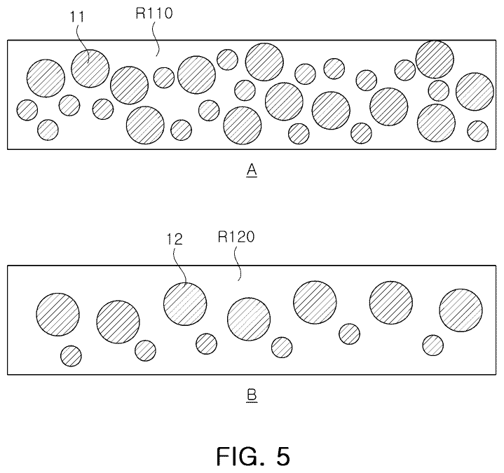

FIG. 6 is a cross-sectional view taken along line I-I′ of FIG. 1, illustrating another modified example of the first embodiment of the present disclosure;

FIG. 7 is a schematic perspective view of a coil component of a second embodiment of the present disclosure;

FIG. 8 is a cross-sectional view taken along line II-II′ of FIG. 7; and

FIG. 9 is a cross-sectional view taken along line II-II′ of FIG. 7, illustrating a modified example of the second embodiment of the present disclosure.

### DETAILED DESCRIPTION

The terms used herein to describe embodiments of the present disclosure is not intended to limit the scope of the present disclosure. The articles “a,” and “an” are singular in that they have a single referent, however the use of the singular form in the present document should not preclude the presence of more than one referent. In other words, elements of the present disclosure referred to in the singular may number one or more, unless the context clearly indicates otherwise. It will be further understood that the terms “comprise,” “comprising,” “include,” and/or “including,” when used herein, specify the presence of stated features, numbers, steps, operations, elements, and/or components but do not preclude the presence or addition of one or more other features, numbers, steps, operations, elements, components, and/or groups thereof.

The terms used in the present specification are merely used to describe particular embodiments and are not intended to limit the present disclosure. An expression used in the singular encompasses the expression of the plural, unless it has a clearly different meaning in the context. In the present specification, it is to be understood that the terms, such as “including” or “having,” etc., are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added. Also, throughout the specification, “on” means to be located above or below a target portion and does not necessarily mean to be located on the upper side with respect to the direction of gravity.

In addition, coupling does not mean only the case of direct physical contact between each component in a contact relationship, but should be used as a concept that encompasses even a case in which another component intervenes between each component so that a component is in contact with the other component.

Since the size and thickness of each component illustrated in the drawings are arbitrarily illustrated for convenience of description, the present disclosure is not necessarily limited to the illustrated.

In the drawings, an X-direction may be defined as a first direction or thickness direction, a Y-direction may be defined as the second direction or length direction, and a Z-direction may be defined as the third direction or width direction. In the following description, the first direction (the X-direction), the second direction (the Y-direction), and the third direction (the Z-direction) each represent both directions, and, for example, the first direction (the X-direction) includes both upward and downward directions with respect to the drawings.

Hereinafter, a coil component according to an embodiment in the present disclosure will be described in detail with reference to the accompanying drawings, and in the description with reference to the accompanying drawings, the same or corresponding components are assigned the same reference numerals and overlapping descriptions thereof will be omitted.

Hereinafter, embodiments of the present invention will be described with reference to specific examples and the accompanying drawings. However, the embodiments of the present invention may be modified in various other forms, and the scope of the present invention is not limited to the embodiments described below. In addition, the embodiments of the present invention are provided to more completely describe the present invention to those skilled in the art. Therefore, the shapes and sizes of elements in the drawings may be exaggerated for a clearer description, and elements indicated by the same reference numerals in the drawings are the same elements.

Various types of electronic components are used in electronic devices, and various types of coil components may be appropriately used between these electronic components for the purpose of removing noise. That is, in electronic devices, coil components may be used as power inductors, high-frequency (HF) inductors, general beads, GHz beads, common mode filters, etc.

### First Embodiment

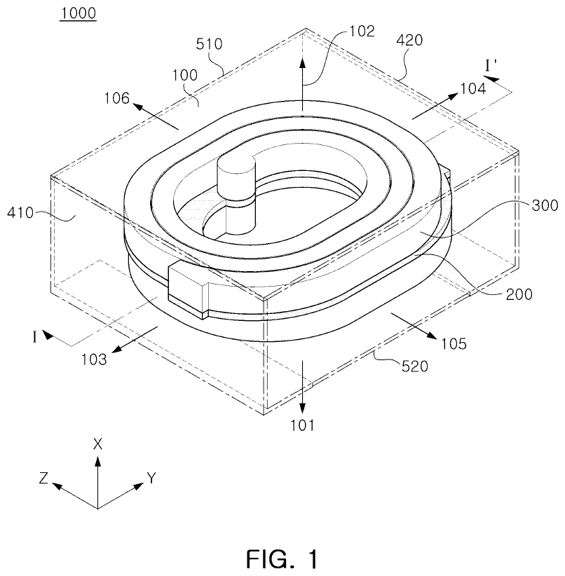

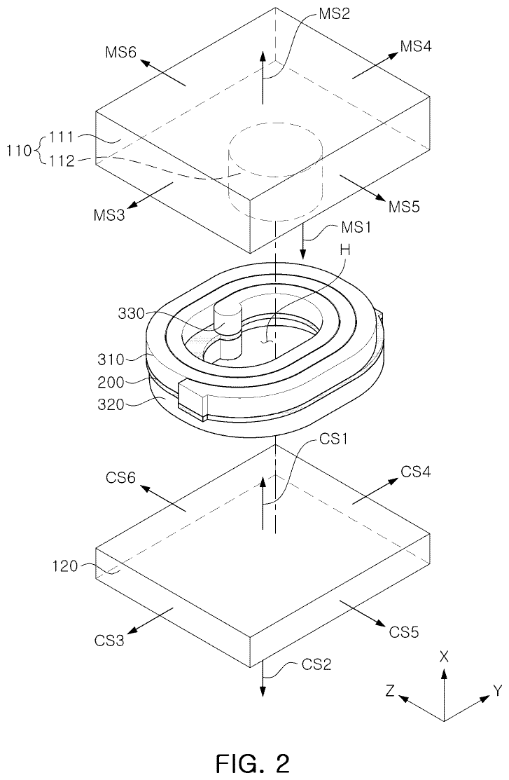

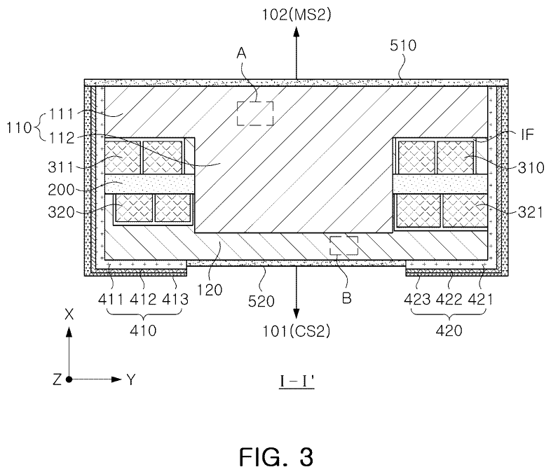

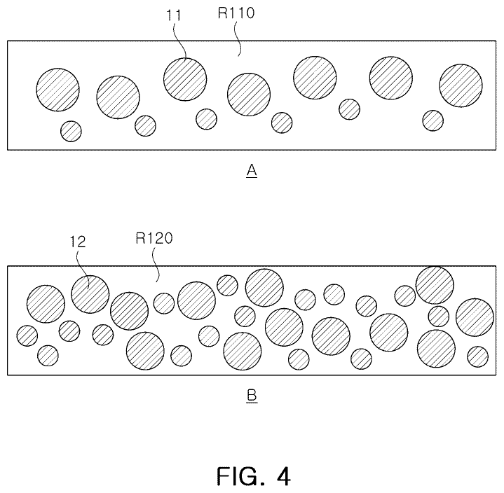

FIG. 1 is a schematic perspective view of a coil component of a first embodiment of the present disclosure. FIG. 2 is an exploded perspective view of a coil of FIG. 1. FIG. 3 is a cross-sectional view taken along line I-I′ of FIG. 1. FIG. 4 is an enlarged view of portions A and B of FIG. 3.

Referring to FIG. 1, the coil component 1000 according to the present embodiment includes a body 100, a support member 200, a coil 300, external electrodes 410 and 420, and a first insulating layer 510.

The body 100 includes the support member 200 and the coil 300 disposed therein and may form the external casing of the coil component 1000. The body 100 may include a first surface 101 and the second surface 102 opposing each other in the first direction (the X-direction) and first to fourth side surfaces 103, 104, 105, and 106 connecting the first surface and the second surface. Specifically, the first side surface 103 and the second side surface 104 may face each other in the second direction (the Y-direction) and connect the first surface 101 and the second surface 102, and the third side surface 105 and the fourth side surface 106 may face each other in the third direction (the Z-direction) and connect the first surface 101 and the second surface 102. The first surface 101 of the body 100 may be provided as a mounting surface when the coil component 1000 is mounted as described below, and thus may be a lower surface of the body 100. The second surface 102 facing the first surface in the first direction (the X-direction) may be an upper surface. The first to fourth side surfaces 103, 104, 105, and 106 may be a plurality of side surfaces connecting the first surface 101 and the second surface 102 of the body 100. The body 100 may be formed, for example, so that the coil component 1000 according to the present embodiment, in which the external electrodes 410 and 420 to be described below are formed, has a length of 0.8 mm, a width of 0.4 mm, and a thickness of 0.8 mm, has a length of 0.8 mm, a width of 0.4 mm, and a thickness of 0.65 mm, has a length of 1.0 mm, a width of 0.7 mm, and a thickness of 0.8 mm, has a length of 1.0 mm, a width of 0.6 mm, and a thickness of 0.8 mm, has a length of 1.0 mm, a width of 0.5 mm, and a thickness of 0.8 mm, has a length of 1.0 mm, a width of 0.5 mm, and a thickness of 0.65 mm, or has a length of 1.0 mm, a width of 0.5 mm, and a thickness of 0.6 mm, but is not limited thereto. For example, the coil component 1000 may be formed to have a length of 4.0 mm and a width of 4.0 mm or may be formed to have a length of 10.0 mm and a width of 10.0 mm. Meanwhile, the aforementioned exemplary numerical values for the lengths, widths, and thicknesses of the coil component 1000 refer to values without reflecting process errors, and thus, numerical values that may be recognized as process errors should be considered to correspond to the aforementioned exemplary numerical values.

The body 100 may include a molded portion 110 and a cover portion 120 disposed on a first surface of the molded portion 110.

Referring to FIG. 2, the molded portion 110 may include a first surface MS1 (a lower surface in FIG. 2) and a second surface MS2 (upper surface in FIG. 2) facing each other in the first direction (the X-direction) and a plurality of side surfaces MS3, MS4, MS5, and MS6 connecting the first surface and the second surface. The first surface MS1 of the molded portion 110 may contact the cover portion 120, and the second surface MS2 of the molded portion 110 may form the second surface 102 of the body 100. The plurality of side surfaces MS3, MS4, MS5, and MS6 of the molded portion 110 may constitute a portion of the plurality of side surfaces 103, 104, 105, and 106 of the body 100.

The molded portion 110 may include a base portion 111 and a core 112. The base portion 111 and the core 112 may be formed together during the same process and may be integrated with each other. Therefore, there may be no boundary between the base portion 111 and the core 112.

The core 112 may be disposed in a protruding form in the center of first surface of the base portion 111 and penetrates the coil 300. For this reason, in this specification, first surface and the second surface of the molded portion 110 may be used as having the same meaning as first surface and the second surface of the base portion 111. The core 112 may protrude from first surface of the base portion 111 and penetrate through a through-hole H of the support member 200 described below.

The base portion 111 may be disposed on top of the core 112 in FIG. 2, and first surface (lower surface) thereof may be in contact with the coil 300. The base portion 111 may not penetrate through an air core formed by the coil 300.

As described above, the molded portion 110 including the base portion 111 and the core 112 may be a T-core having a ‘T’ shape. In addition, the second surface MS2 of the molded portion 110 may form the second surface 102 of the body, and here, the second surface 102 of the body may be the upper surface, so the molded portion 110 of the coil component 1000 according to the present embodiment may have a shape in which ‘T’ is disposed upside down in the cross-sectional view as in FIG. 3.

The cover portion 120 may be disposed on first surface of the molded portion 110. In FIG. 2, the cover portion 120 may be disposed below the molded portion 110, and the coil 300 may be disposed therein. The cover portion 120 may be disposed on the molded portion 110 and the coil 300 and then pressed to be combined with the molded portion 110.

The cover portion 120 may include first surface CS1 (the upper surface in FIG. 2) contacting first surface of the molded portion 110, the second surface CS2 facing the first surface in the first direction (the X-direction), and a plurality of side surfaces CS3, CS4, CS5, and CS6 connecting the first surface and the second surface. The second surface CS2 of the cover portion 120 may form the first surface 101 of the body 100. The plurality of side surfaces CS3, CS4, CS5, and CS6 of the cover portion 120 may form the plurality of side surfaces 103, 104, 105, and 106 of the body 100 together with the plurality of side surfaces MS3, MS4, MS5, and MS6 of the molded portion 110.

The molded portion 110 and the cover portion 120 may include a magnetic material. In the present embodiment, the molded portion 110 and the cover portion 120 may include magnetic metal particles as the magnetic material. Specifically, the molded portion 110 may include a first magnetic metal particle 11, and the cover portion 120 may include a second magnetic particle 12.

The permeabilities of the molded portion 110 and the cover portion 120 may be different. The permeabilities of the molded portion 110 and the cover portion 120 may be adjusted in the following manner.

The molded portion 110 and the cover portion 120 may have different particle size distributions. Specifically, in a cross-sectional sample collected in the X-Y-direction as illustrated in FIG. 4, the particle size distributions analyzed based on the areas may be different.

The diameter of the first magnetic metal particle 11 may be different from the diameter of the second magnetic metal particle 12. Meanwhile, in this specification, the difference in the diameters of the magnetic metal particles 11 and 12 may mean that the average diameters are different. In addition, the difference in the average diameters of the magnetic metal particles 11 and 12 may mean that the particle size distribution values expressed as D50 or D90 are different.

In addition, referring to FIG. 4, The resin R content may be obtained as a ratio of the area occupied by the resin R to the total area in a cross-sectional sample collected in the X-Y-direction. Since the molded portion 110 may have a lower filling rate of the magnetic metal particles compared to the cover portion 120, the cover portion 120 may exhibit a relatively low permeability (relative permeability). The filling rate of the magnetic metal particles may be obtained as a volume fraction or area fraction of the magnetic metal particles included in the resin R. However, the present disclosure is not necessarily limited thereto, and the molded portion 110 may have a lower resin R content compared to the cover portion 120, and the filling rate of the magnetic metal particles may be higher.

The magnetic metal particles 11 and 12 may include at least one selected from the group consisting of iron (Fe), silicon (Si), chromium (Cr), cobalt (Co), molybdenum (Mo), aluminum (Al), niobium (Nb), copper (Cu), and nickel (Ni). For example, the magnetic metal powder particles 11 and 12 may be at least one selected from the group consisting of pure iron powder particles, Fe—Si alloy powder particles, Fe—Si—Al alloy powder particles, Fe—Ni alloy powder particles, Fe—Ni—Mo alloy powder particles, Fe—Ni—Mo—Cu alloy powder particles, Fe—Co alloy powder particles, Fe—Ni—Co alloy powder particles, Fe—Cr alloy powder particles, Fe—Cr—Si alloy powder particles, Fe—Si—Cu—Nb alloy powder particles, Fe—Ni—Cr alloy powder particles, and Fe—Cr—Al alloy powder particles.

The magnetic metal particles 11 and 12 may be amorphous or crystalline. For example, the magnetic metal particles 11 and 12 may be Fe—Si—B—Cr amorphous alloy powder particles, but are not necessarily limited thereto.

The surface of each of the magnetic metal particles 11 and 12 may be covered with an insulating material. The insulating material may be an organic insulating material including, but not limited to, epoxy, polyimide, liquid crystal polymer, etc., alone or in combination or may be an oxide insulating film including a metal component of the magnetic metal particles 11 and 12 or an inorganic insulating material, such as SiOₓ, Sinₓ, or phosphate.

The resin R may include epoxy, polyimide, liquid crystal polymer, etc., alone or in combination, but is not limited thereto.

The molded portion 110 may be formed by filling a mold having a ‘T’-shaped cavity with a composite material including a magnetic material and a resin. A molding process of applying high temperature and high pressure to the magnetic material or composite material in the mold may be additionally performed, but is not limited thereto.

The cover portion 120 may be formed by disposing the coil 300 on the molded portion 110 described above in the mold and then filling the mold with the composite material including a magnetic material and a resin. As described above, since the molded portion 110 and the cover portion 120 have different particle size distributions of the magnetic metal powder particles, a boundary may be formed in a portion at which the molded portion 110 and the cover portion 120 meet.

The coil component according to the present embodiment includes the support member 200 disposed in the body. Referring to FIG. 2, the support member 200 may include first surface (the upper surface in FIG. 2) and the second surface (the lower surface in FIG. 2) facing each other in the first direction (the X-direction), and the coil 300 to be described below may be disposed on at least one of the first surface and the second surface.

Referring to FIG. 2, the support member 200 may have the through-hole formed in the first surface and the second surface. The core 112 of the molded portion 110 may be disposed in the through-hole H. The coil component 1000 according to the present embodiment may apply a T-core structure to a thin film coil component. As described above, the T-core structure may make it easy to apply heterogeneous materials as magnetic materials of the molded portion 110 and the cover portion 120. In addition, since the T-core is formed using a mold, it may be easy to increase the density of the magnetic material through high-pressure molding.

The support member 200 may be in contact with the core 112 of the molded portion 110 through a side surface forming the through-hole H, but is not limited thereto.

The support member 200 may be formed of an insulating material including at least one of a thermosetting insulating resin, such as an epoxy resin, a thermoplastic insulating resin, such as polyimide, or a photosensitive insulating resin or may be formed of an insulating material prepared by impregnating a reinforcing material, such as glass fiber or inorganic filler, in the insulating resin. As an example, the support member 200 may be formed of insulating materials, such as copper clad laminate (CCL), prepreg, Ajinomoto build-up film (ABF), FR-4, a bismaleimide triazine (BT) resin, photo imageable dielectric (PID), etc., but is not limited thereto

As an inorganic filler, at least one selected from the group consisting of silica (SiO₂), alumina (Al₂O₃), silicon carbide (SiC), barium sulfate (BaSO₄), talc, mud, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃) and calcium zirconate (CaZrO₃) may be used.

When the support member 200 is formed of an insulating material including a reinforcing material, the support member 200 may provide more excellent rigidity. If the support member 200 is formed of an insulating material that does not contain glass fibers, the support member 200 is advantageous in reducing a thickness of the entire coil 300. When the support member 200 is formed of an insulating material including a photosensitive insulating resin, the number of processes may be reduced, which is advantageous in reducing production costs, and micro-hole processing is possible.

The coil component according to the present embodiment includes the coil 300. The coil 300 may be disposed in the body 100 and may be disposed on at least first surface of the support member 200.

The coil 300 is disposed in the body 100. Specifically, the coil 300 may be disposed on the molded portion 110 and covered by the cover portion 120. The coil 300 forms at least one turn, and the core 112 of the molded portion 110 may be disposed in the air core formed by the turns of the coil. In addition, the cover portion 120 may be disposed in an outer region of the turn.

The coil 300 may include a first coil pattern 310 disposed on first surface of the support member 200 (in the present embodiment, the upper surface in the drawing) and a second coil pattern 320 disposed on the second surface of the support member 200 (in the present embodiment, the lower surface in the drawing).

The coil 300 may include the first coil pattern 310 and a first lead portion 311 disposed on first surface of the support member 200. The coil 300 may include the second coil pattern 320 and a second lead portion 321 disposed on the second surface of the support member 200.

The first coil pattern 310 and the second coil pattern 320 form one or more turns centered on the core 112 and may have a planar spiral shape. Specifically, one or more turns may be formed based on a central axis substantially parallel to the first direction (the X-direction). However, the present disclosure is not limited thereto.

Referring to FIG. 3, on the upper surface of the support member 200, the first coil pattern 310 contacts and is connected to the first lead portion 311. On the lower surface of the support member 200, the second coil pattern 320 contacts and is connected to the second lead portion 321.

The first lead portion 311 extends to the first side surface 103 and is connected to the first external electrode 410 described below. The second lead portion 321 extends to the second side surface 104 and is connected to the second external electrode 420 described below.

A via 330 penetrates through the support member 200 and contacts each of the first coil pattern 310 and the second coil pattern 320. Accordingly, the coil 300 may function as a single coil as a whole.

At least one of the components constituting the coil 300 may include one or more conductive layers. For example, when the coil 300 is formed by applying a plating process to the surface of the support member 200, at least one of the components constituting the coil 300 may include a first conductive layer formed by electroless plating, etc. and a second conductive layer disposed on the first conductive layer. The first conductive layer may be a seed layer for forming the second conductive layer on the support member 200 by plating, and the second conductive layer may be an electroplated layer. Here, the electroplated layer may have a single-layer structure or a multilayer structure. The electroplated layer having a multilayer structure may be formed as a conformal film structure in which one electroplated layer is covered by another electroplated layer or may be formed in a shape in which another electroplated layer is stacked on only first surface of one electroplated layer. The coil 300 may be formed of a conductive material, such as copper (Cu), aluminum (Al), silver (Ag), tin (Sn), gold (Au), nickel (Ni), lead (Pb), titanium (Ti), or alloys thereof, but is not limited thereto.

An insulating film IF may be formed on the surface of the coil 300. Specifically, the insulating film IF may be disposed between the coil 300 and the body 100. The insulating film IF may be formed on the surface of the support member 200 on which the coil 300 is formed, but is not limited thereto. The insulating film IF may be in contact with the first surface MS1 of the molded portion 111.

The insulating film IF is for electrically separating the coil 300 and the body 100 and may include a known insulating material, such as parylene, but is not limited thereto. As another example, the insulating film IF may include an insulating material, such as an epoxy resin other than parylene. The insulating film IF may be formed by a vapor deposition method, but is not limited thereto. As another example, the insulating film IF may be formed by stacking and curing an insulating film for forming the insulating film IF on both sides of the support member 200 on which the coil 300 is formed or may be formed by applying and curing an insulating paste for forming the insulating film IF on both sides of the support member 200 on which the coil 300 is formed. Meanwhile, for the aforementioned reason, the insulating film IF is a component that may be omitted in the present embodiment. That is, if the body 100 has sufficient electrical resistance at the designed operating current and voltage of the coil component 1000, the insulating film IF may be omitted in the present embodiment.

The external electrodes 410 and 420 are disposed on the surface of the body 100. The external electrodes may include first and second external electrodes 410 and 420 connected to the first and second coil patterns 310 and 320, respectively.

Specifically, the first external electrode 410 may be disposed on the first side surface 103 and the first surface 101 of the body 100 and may be connected to the first lead portion 311. The second external electrode 420 may be disposed on the second side surface 104 and the first surface 101 of the body 100 and may be connected to the second lead portion 321. The first and second external electrodes 410 and 420 may have an ‘L’ shape.

The external electrodes 410 and 420 may be disposed on the first surface 101 of the body 100, and the first surface 101 of the body 100 may be provided as a mounting surface of the coil component when mounted on a substrate. The external electrodes 410 and 420 may play a role in electrically connecting the coil 300 in the coil component 1000 to an electronic device when the coil component 1000 is mounted on the electronic device, etc.

The external electrodes 410 and 420 may not be disposed on the second surface 102 of the body 100. Instead, a first insulating layer 510 described below may be disposed on the second surface 102 of the body 100.

The external electrodes 410 and 420 may be formed of a conductive material, such as copper (Cu), aluminum (Al), silver (Ag), tin (Sn), gold (Au), nickel (Ni), lead (Pb), chromium (Cr), titanium (Ti), or alloys thereof, but are not limited thereto. The first and second external electrodes 410 and 420 may be formed in a structure of a plurality of layers. For example, first metal layers 411 and 421 through which the first and second external electrodes 410 and 420 are connected to the coil 300 may be conductive resin layers including a conductive powder particle including at least one of copper (Cu) and silver (Ag) and an insulating resin or copper (Cu) plating layers. In addition, a second metal layer may have a double-layer structure of a nickel (Ni) plating layer and a tin (Sn) plating layer. First layers 412 and 422 may be formed by electroplating, formed by vapor deposition, such as sputtering, or formed by applying and curing a conductive paste including conductive powder particles, such as copper (Cu) and/or silver (Ag), and second layers 413 and 423 may be formed by electroplating.

The first insulating layer 510 may be disposed on the second surface 102 of the body 100. The first insulating layer 510 may be in contact with the second surface MS2 of the molded portion 110.

The first insulating layer 510 may function as a plating resist when the first metal layers 411 and 421 of the external electrode 410 and 420 are formed by plating on the surface of the body 100. Therefore, the first insulating layer 510 may be formed on the surface of the body 100 before the first metal layers 411 and 421 of the external electrode 410 and 420, thereby defining regions on the surface of the body 100 in which the first metal layers 411 and 421 are to be formed. However, the scope of the present disclosure is not limited thereto.

A second insulating layer 520 may be disposed on the first surface 101 of the body 100. The second insulating layer 520 may be in contact with the second surface CS2 of the cover portion 120.

The second insulating layer 520 may function as a plating resist when the first metal layers 411 and 421 of the external electrodes 410 and 420 are formed by plating on the surface of the body 100. Therefore, the second insulating layer 520 may be formed on the surface of the body 100 before the first metal layers 411 and 421 of the external electrode 410 and 420, thereby defining regions on the surface of the body 100 in which the first metal layers 411 and 421 are to be formed. However, the scope of the present disclosure is not limited thereto.

The first and second insulating layers 510 and 520 may include thermoplastic resins, such as polystyrene, vinyl acetate, polyester, polyethylene, polypropylene, polyamide, rubber, and acrylic, thermosetting resins, such as phenol, epoxy, urethane, melamine, and alkyd, photosensitive resins, parylene, SiOₓ, or SiNₓ.

The first and second insulating layers 510 and 520 may be formed by applying a liquid insulating resin to the surface of the body 100, applying an insulating paste to the surface of the body 100, stacking an insulating film on the surface of the body 100, or forming an insulating resin on the surface of the body 100 by vapor deposition. In the case of the insulating film, a dry film (DF) including a photosensitive insulating resin, an Ajinomoto build-up film (ABF) not including a photosensitive insulating resin, or a polyimide film, etc. may be used.

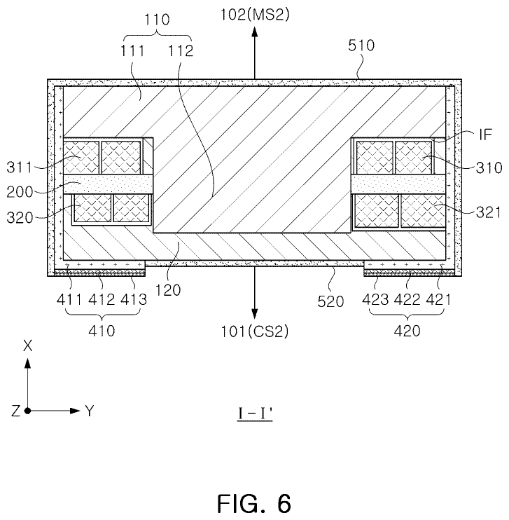

FIG. 6 is a cross-sectional view taken along line I-I′ of FIG. 1, illustrating another modified example of the first embodiment of the present disclosure.

Referring to FIG. 6, the first insulating layer 510 may extend onto the first side surface 103 and the second side surface 104 of the body 100. The first insulating layer 510 may cover the first metal layers 411 and 421 disposed on the first side surface 103 and the second side surface 104 of the body 100.

The first insulating layer 510 may be disposed on the first side surface 103 and the second side surface 104 of the body 100, thereby implementing a coil component having a structure of a lower electrode. The second metal layer may not be disposed on the first side surface 103 and the second side surface 104 of the body 100 and may be disposed only on the first surface 101 of the body 100.

### Second Embodiment

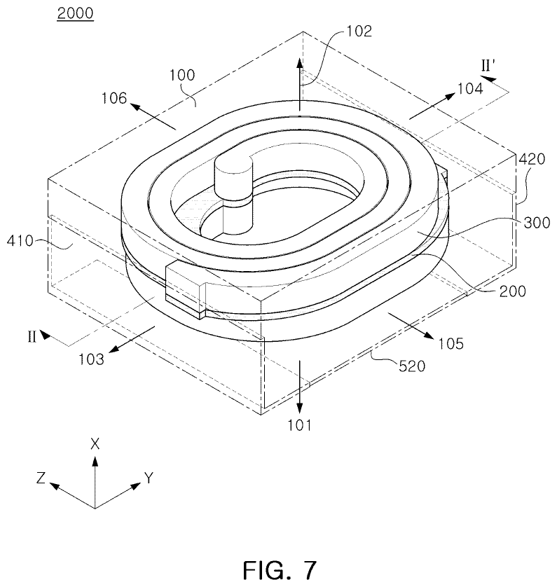

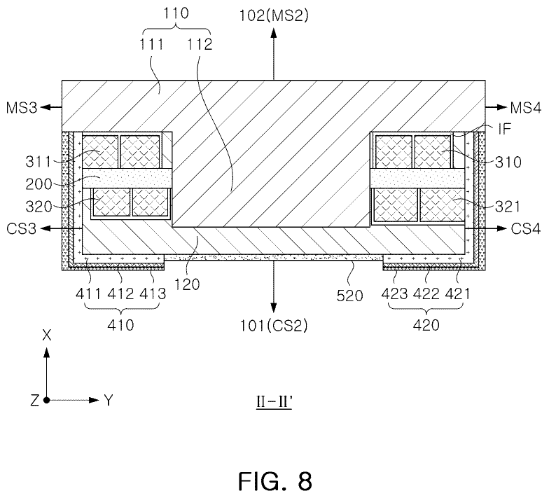

FIG. 7 is a schematic perspective view of a coil component according to a second embodiment of the present disclosure. FIG. 8 is a cross-sectional view taken along line II-II′ of FIG. 7.

Referring to FIGS. 7 and 8, in the coil component 2000 according to the second embodiment, the molded portion 110 may include ferrite as a magnetic material.

Ferrite may be, for example, at least one of spinel type ferrites, such as Mg—Zn type, Mn—Zn type, Mn—Mg type, Cu—Zn type, Mg—Mn—Sr type, and Ni—Zn type, hexagonal type ferrites, such as Ba—Zn type, Ba—Mg type, Ba—Ni type, Ba—Co type, and Ba—Ni—Co type, garnet type ferrites, such as Y type, and Li type ferrite.

When the molded portion 110 includes ferrite as a magnetic material, the first insulating layer 510 may not be disposed on the surfaces MS2, MS3, MS4, MS5, and MS6 of the molded portion 110 in which the molded portion 110 is exposed to the outer surface of the body 100. Since the first insulating layer 510 may be omitted, the molded portion 110 may be additionally disposed in the space in which the first insulating layer 510 is omitted, and the volume of the magnetic body may be secured.

The plurality of side surfaces MS3, MS4, MS5, and MS6 of the molded portion 110 may be positioned on an outer side the body 100 than the plurality of side surfaces CS3, CS4, CS5, and CS6 of the cover portion 120.

The external electrodes 410 and 420 may not be disposed on the plurality of side surfaces MS3, MS4, MS5, and MS6 of the molded portion 110. The plurality of side surfaces MS3, MS4, MS5, and MS6 of the molded portion 110 may function as a plating resist when the first metal layers 411 and 421 of the external electrode 410 and 420 are formed.

The cover portion 120 may include a resin and magnetic metal particles dispersed in the resin.

Since the molded portion 110 and the cover portion 120 each include different magnetic materials, a boundary may be formed in a portion in which the molded portion 110 and the cover portion 120 meet.

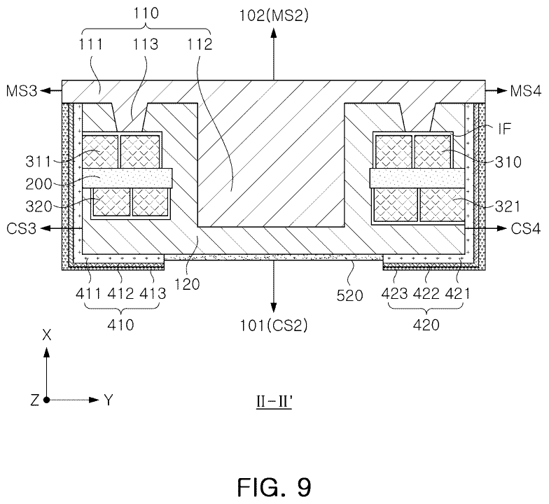

FIG. 9 is a cross-sectional view taken along line II-II′ of FIG. 7, illustrating a modified example of the second embodiment of the present disclosure.

Referring to FIG. 9, first surface MS1 of the molded portion 110 may further include a protrusion 113 protruding from first surface MS1.

The protrusion 113 may be in contact with the coil 300 or the insulating film IF covering the coil. At least a portion of the cover portion 120 may be disposed in a space between the molded portion 110 and the coil 300. In addition, at least a portion of the cover portion 120 may be disposed in the through-hole H of the support member 200.

As one effect of the present disclosure, the coil component capable of diversifying the structure and characteristics may be provided.

While example embodiments have been illustrated and described above, it will be apparent to those skilled in the art that modifications and variations could be made without departing from the scope of the present disclosure as defined by the appended claims.

What is claimed is:

1. A coil component comprising:
a body including a first surface and a second surface facing each other in a first direction and a first side surface and a second side surface, facing each other in a second direction, and including a magnetic material;
a support member disposed within the body, including a first surface of the support member and a second surface of the support member facing each other in the first direction, and having a through-hole formed in the first surface of the support member and the second surface of the support member;
a coil disposed on at least one of the first surface of the support member and the second surface of the support member;
an external electrode disposed on the first side surface, the second side surface, and the first surface of the body; and
a first insulating layer disposed on the second surface of the body,
wherein the body includes a molded portion including a first surface of the molded portion and a second surface of the molded portion opposing each other in the first direction and a plurality of side surfaces connecting the first surface of the molded portion and the second surface of the molded portion and including a core protruding from the first surface of the molded portion and penetrating through the through-hole and a cover portion disposed on the first surface of the molded portion, and
the second surface of the molded portion forms the second surface of the body.

2. The coil component of claim 1, wherein the molded portion and cover portion include a resin and magnetic metal particles dispersed in the resin.

3. The coil component of claim 2, wherein the molded portion includes a first magnetic metal particle, and the cover portion includes a second magnetic metal particle, and the molded portion and the cover portion have different particle size distributions.

4. The coil component of claim 2, wherein a resin content of the molded portion is greater than a resin content of the cover portion.

5. The coil component of claim 1, wherein the external electrode is not disposed on the second surface of the body.

6. The coil component of claim 1, wherein the first insulating layer covers the external electrode disposed on the first side surface and the second side surface of the body.

7. The coil component of claim 1, wherein the cover portion includes a first surface of the cover portion contacting the first surface of the molded portion, a second surface of the cover portion facing the first surface of the cover portion, and a plurality of side surfaces connecting the first surface of the cover portion and the second surface of the cover portion, and the second surface of the cover portion forms the first surface of the body.

8. The coil component of claim 1, wherein the external electrode includes a first external electrode disposed on the first side surface and the first surface of the body and a second external electrode disposed on the second side surface and the first surface of the body.

9. The coil component of claim 1, wherein the coil includes a first coil pattern disposed on the first surface of the support member, a second coil pattern disposed on the second surface of the support member, and a via penetrating through the support member and connecting the first and second coil patterns.

10. The coil component of claim 1, wherein the molded portion has a T-shape in cross-sectional view.

11. A coil component comprising:
a body including a first surface and a second surface facing each other in a first direction and a first side surface and a second side surface, facing each other in a second direction, and including a magnetic material;
a support member disposed within the body, including a first surface of the support member and a second surface of the support member facing each other in the first direction, and having a through-hole formed in the first surface of the support member and the second surface of the support member;
a coil disposed on at least one of the first surface and the second surface of the support member; and
an external electrode disposed on the first side surface and the second side surface of the body,
wherein the body includes a molded portion including a first surface of the molded portion and a second surface of the molded portion opposing each other in the first direction and a plurality of side surfaces connecting the first surface of the molded portion and the second surface of the molded portion and including a core protruding from the first surface of the molded portion and penetrating through the through-hole and a cover portion disposed on the first surface of the molded portion,
the molded portion includes ferrite, and
the cover portion includes a resin and magnetic metal particles dispersed in the resin.

12. The coil component of claim 11, wherein the cover portion includes a first surface of the cover portion contacting the first surface of the molded portion, a second surface of the cover portion facing the first surface of the cover portion, and a plurality of side surfaces connecting the first surface of the cover portion and the second surface of the cover portion, and the plurality of side surfaces of the molded portion are located outward of the plurality of side surfaces of the cover portion with respect to the body.

13. The coil component of claim 11, wherein the external electrode is not disposed on the plurality of side surfaces of the molded portion.

14. The coil component of claim 11, wherein the molded portion further includes a protrusion protruding from the first surface of the molded portion, and at least a portion of the cover portion is disposed between the first surface of the molded portion and the coil.

15. The coil component of claim 11, wherein the second surface of the molded portion forms the second surface of the body.

16. The coil component of claim 11, wherein the molded portion has a T-shape in cross-sectional view.
